(19) United States
(12) Patent Application Publication
(10) Pub. No.: US 2013/0187967 A1
(43) Pub. Date: Jul. 25, 2013

(54) Liquid Ejecting Apparatus and Liquid Ejecting Method

(71) Applicant: SEIKO EPSON CORPORATION, Tokyo (JP)

(72) Inventor: Akira ABE, Matsumoto-shi (JP)

(73) Assignee: SEIKO EPSON CORPORATION, Tokyo (JP)

(21) Appl. No.: 13/741,167

(22) Filed: Jan. 14, 2013

(30) Foreign Application Priority Data
Jan. 23, 2012 (JP) 2012-010660

(51) Int. Cl. B41J 2/07

(52) U.S. Cl. CPC B41J 2/07
USPC 347/11

(57) ABSTRACT

A liquid ejecting apparatus which includes: an origin drive signal generation unit which generates an origin drive signal; a signal modulation unit which modulates the origin drive signal, and makes the origin drive signal as an origin modulation signal; a signal amplification unit which amplifies the origin modulation signal, and makes the origin modulation signal as a modulation signal; a signal conversion unit which converts the modulation signal to a fire drive signal, and a liquid ejecting unit which ejects liquid according to the fire drive signal, in which a frequency of the origin modulation signal, or the fire modulation signal becomes maximum when the origin drive signal is a predetermined value.

### BACKGROUND

1. Technical Field

The present invention relates to a liquid ejecting apparatus, and a liquid ejecting method.

2. Related Art

An ink jet printer has been widely used in which an image, or a document is recorded by ejecting ink onto a printing medium from a plurality of nozzles which are provided at a printing head. In such an ink jet printer, a predetermined amount of ink is ejected from a nozzle at a predetermined timing when an actuator which is provided corresponding to each nozzle of the printing head is driven according to a fire drive signal which is supplied from a driving circuit.

A technology has been known in which, in a driving circuit which drives a printing head, a drive waveform signal as a reference of a fire drive signal is modulated using a pulse width modulation (PWM, for short) method, and the fire drive signal is generated by performing a power amplification with respect to the modulated signal (for example, refer to JP-A-2007-168172).

In the driving circuit in the related art, since a modulation frequency in a modulation circuit is fixed, a minimum positive pulse width and negative pulse width which can be treated in the modulation circuit are limited to a fixed value due to the circuit characteristics, and a pulse signal which is less than the fixed value is lost on the way. For this reason, since a wider output dynamic range is secured by obtaining a wide variation width of a signal level (pulse duty ratio) in the driving circuit in the related art, there is room for improvement.

In addition, such a problem is not limited to an ink jet printer, and is a common problem when liquid is ejected according to a fire drive signal.

### SUMMARY

An advantage of some aspects of the invention is to secure a wide output dynamic range of a fire drive signal when liquid is ejected according to a fire drive signal.

The invention can be realized in the following forms or application examples.

### Application Example 1

A liquid ejecting apparatus includes an origin drive signal generation unit which generates an origin drive signal; a signal modulation unit which generates an origin modulation signal by modulating the origin drive signal using a self oscillating-type pulse density modulation method; a signal amplification unit which generates a fire modulation signal by amplifying the origin modulation signal; a signal conversion unit which converts the fire modulation signal to a fire drive signal; and a liquid ejection unit which ejects liquid according to the fire drive signal, in which an oscillating frequency in the signal modulation unit is lower than an oscillating frequency when the origin drive signal is the predetermined value, if the origin drive signal is lower than a predetermined value, and is also lower than the oscillating frequency when the origin drive signal is the predetermined value, even if the origin drive signal is higher than the predetermined value.

In the liquid ejecting apparatus, the oscillating frequency in the signal modulation unit, in which the modulation is performed using a self oscillating-type pulse density modulation method, is lower than the oscillating frequency when the origin drive signal is the predetermined value, if the origin drive signal is lower than the predetermined value, and is also lower than the oscillating frequency when the origin drive signal is the predetermined value, even if the origin drive signal is higher than the predetermined value. For this reason, in the signal modulation unit, since an oscillating period becomes long even if the negative pulse width is limited to the fixed value due to the circuit property which is described above at a portion in which the origin drive signal is higher than the predetermined value, it is possible to obtain a signal of which an output pulse duty ratio is large compared to a PWM method in the related art in which the frequency is fixed. On the other hand, even when the positive pulse width is limited to the fixed value due to the circuit characteristics as described above, it is possible to obtain a signal with a smaller pulse duty ratio, since the oscillating period becomes long at a portion in which the origin drive signal is lower than the predetermined value, similarly, it is possible to secure a larger pulse duty ratio variation width as a whole. For this reason, in the liquid ejecting apparatus, it is possible to secure a wide output dynamic range of a driving signal.

### Application Example 2

In the liquid ejecting apparatus according to Application Example 1, the oscillating property of the signal modulation unit is that the oscillating frequency is increased along with an increase in a current value, or a voltage value of the origin drive signal when the origin drive signal is in a range of the predetermined value or less, and is decreased along with the increase in the current value, or the voltage value of the origin drive signal when the origin drive signal is in a range of the predetermined value or more.

In the liquid ejecting apparatus, in the oscillating property of the signal modulation unit, the oscillating frequency is increased along with the increase in the current value, or the voltage value of the origin drive signal when the origin drive signal is in a range of the predetermined value or less, and is decreased along with the increase in the current value, or the voltage value of the origin drive signal when the origin drive signal is in a range of the predetermined value or more. For this reason, in the signal modulation unit, a wider range of pulse duty ratio variation range can be secured, since it is possible to treat a signal of which a pulse duty ratio is larger at a portion at which the value of the origin drive signal is extremely large, and to treat a signal of which a pulse duty ratio is smaller at a portion at which the value of the origin drive signal is extremely small. For this reason, in the liquid ejecting apparatus, it is possible to secure a wider output dynamic range of the fire drive signal.

### Application Example 3

In the liquid ejecting apparatus according to Application Example 1, the signal modulation unit receives the fire modulation signal as a feedback signal, and corrects the generated origin modulation signal.

In the liquid ejecting apparatus, it is possible to execute a modulation of a self oscillating-type pulse density modulation method using the signal modulation unit.

In addition, the present invention can be executed in various modes, for example, in a form of a liquid ejecting method, a driving circuit for driving a liquid ejecting head and a driving method, a liquid ejecting apparatus which has such a liquid ejecting head, and a driving circuit, and a control method thereof, a printing device which has such a liquid ejecting head, and a driving circuit, and performs printing by ejecting ink as liquid, and a printing method, a computer program for executing these methods, or functions of these devices, a recording medium on which the computer program is recorded, or the like.

### BRIEF DESCRIPTION OF THE DRAWINGS

The invention will be described with reference to the accompanying drawings, wherein like numbers reference like elements.

FIG. 1 is an explanatory diagram which illustrates a schematic configuration of a printing system according to a first example of the present invention.

FIG. 2 is an explanatory diagram which illustrates a schematic configuration centered on a control unit of a printer.

FIG. 3 is an explanatory diagram which illustrates an example of various signals which are supplied to a printing head.

FIG. 4 is an explanatory diagram which illustrates a configuration of a switching controller of the printing head.

FIG. 5 is an explanatory diagram which illustrates a schematic configuration of a driving circuit which drives the printing head.

FIG. 6 is an explanatory diagram which illustrates a functional block of a modulation circuit.

FIG. 7 is an explanatory diagram which illustrates an example of a specific functional configuration of the driving circuit.

FIG. 8 is an explanatory diagram which illustrates an oscillating frequency in the modulation circuit.

### DESCRIPTION OF EXEMPLARY EMBODIMENTS

Subsequently, embodiments of the present invention will be described based on examples.

### A. First Example

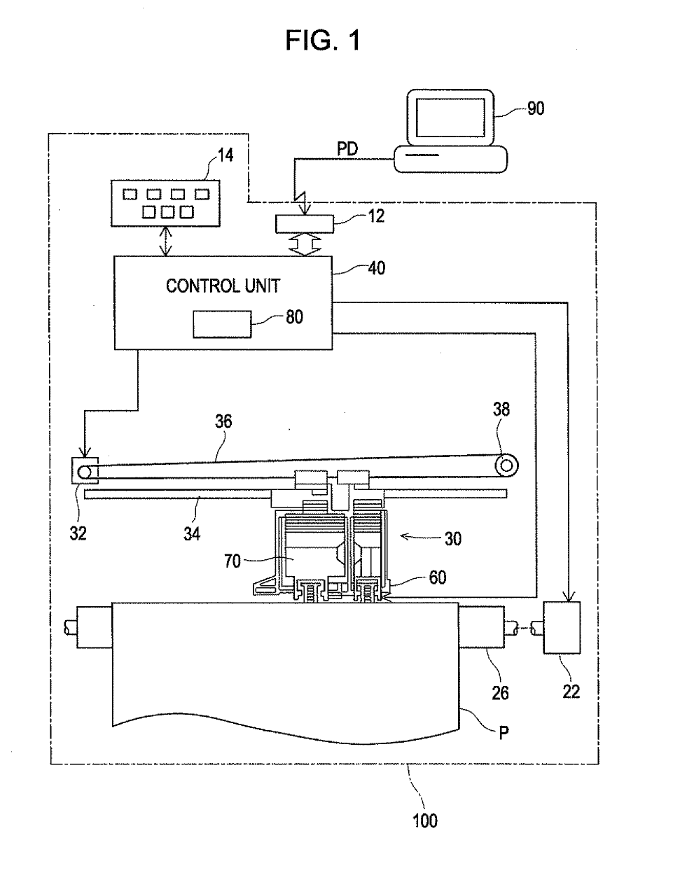

FIG. 1 is an explanatory diagram which illustrates a schematic configuration of a printing system according to a first example of the present invention. A printing system in the example includes a printer 100, and a host computer 90 which supplies printing data PD to the printer 100. The printer 100 is connected to the host computer 90 through a connector 12.

The printer 100 according to the example is an ink jet printer as a type of a liquid ejecting apparatus which ejects liquid. The printer 100 forms ink dots on a printing medium by ejecting ink as liquid, and records characters, figures, images, or the like according to the printing data PD, in this manner.

As illustrated in FIG. 1, the printer 100 includes a carriage 30 which mounts the printing head 60, a movement mechanism which performs main scanning in which the carriage 30 is reciprocated along the direction which is parallel to an axis of a platen 26, a transport mechanism which performs sub-scanning in which a sheet P as a printing medium is transported to a direction which intersects the main scanning direction (sub-scanning direction), an operation panel 14 which performs various operations of instruction and setting relating to printing, and a control unit 40 which controls each unit of the printer 100. In addition, the carriage 30 is connected to the control unit 40 through a flexible cable (FFC) which is not shown.

The transport mechanism which transports the sheet P has a paper feed motor 22. A rotation of the paper feed motor 22 is transported to a sheet transport roller (not shown) through a gear train (not shown), and the sheet P is transported along the sub-scanning direction due to the rotation of the sheet transport roller.

The movement mechanism which causes the carriage 30 to reciprocate includes a carriage motor 32, a sliding axis 34 which is stretched in parallel to an axis of the platen 26, and holds the carriage 30 to be slid, and a pulley 38 at which an endless belt 36 is extended between the carriage motor 32 and the pulley.

A rotation of the carriage motor 32 is transmitted to the carriage 30 through a driving belt 36, and due to this, the carriage 30 reciprocates along the sliding axis 34. In addition, in order to detect a position of the carriage 30 (printing head 60) along the main scanning direction, the printer 100 includes an encoder (not shown) which outputs a pulsatile signal to the control unit 40 along with the rotation of the carriage motor 32. The control unit 40 generates a timing signal PTS which defines an input timing of a driving signal selection signal SI & SP to a shift register 63 to be described later based on the pulsatile signal which is output from the encoder. The control unit 40 includes a driving circuit 80. A configuration of the driving circuit 80 will be described later.

The carriage 30 is mounted with a plurality of ink cartridges 70 in which ink of each predetermined color (for example, cyan (C), light cyan (Lc), magenta (M), light magenta (Lm), yellow (Y), black (K)) is accommodated. The ink which is accommodated in the ink cartridge 70 which is mounted to the carriage 30 is supplied to the printing head 60. In addition, the printing head 60 includes a plurality of nozzles which eject ink, and actuators (nozzle actuator) which are provided corresponding to each nozzle. According to the example, a piezoelectric element as nozzle actuator which is a capacitive load is used. When the nozzle actuator is driven by a fire drive signal to be described later, a vibrating plate in a cavity (pressure chamber) which communicates with the nozzle is displaced, and causes a change in pressure in the cavity, whereby ink is ejected from a corresponding nozzle due to the change in pressure. It is possible to adjust an ejecting amount (that is, size of dots to be formed) of ink by adjusting a peak value of the fire drive signal which is used when driving the nozzle actuator, or inclination of increase and decrease in a voltage.

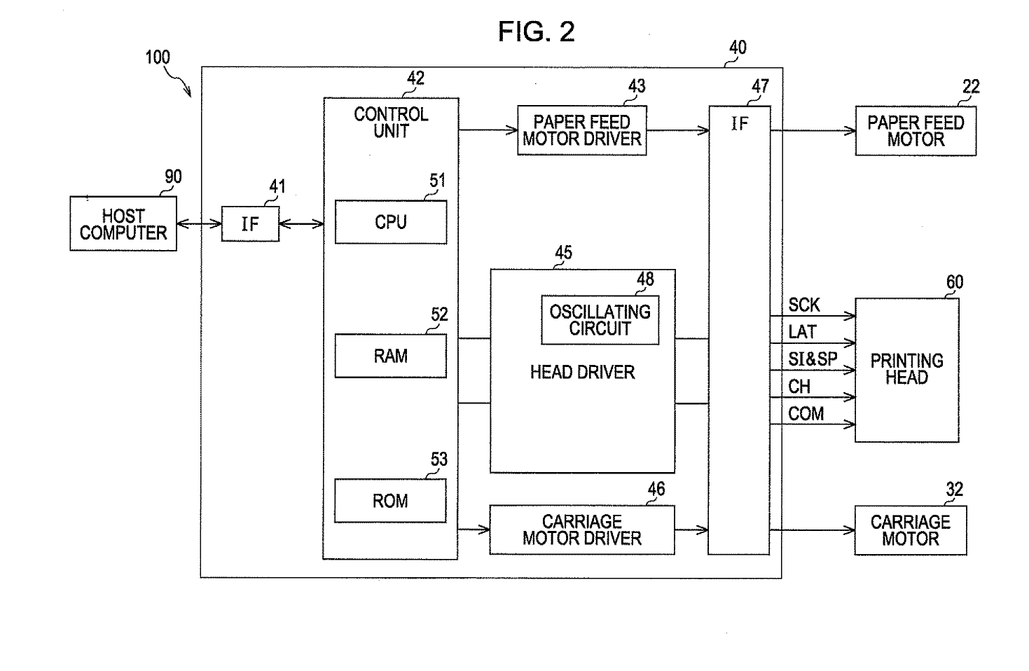

FIG. 2 is an explanatory diagram which illustrates a schematic configuration in which the control unit 40 of the printer 100 is main. The control unit 40 includes an interface 41 which inputs print data PD or the like which is input from the host computer 90, a control section 42 which performs a predetermined arithmetic processing based on the printing data PD which is input through the interface 41, a paper feed motor driver 43 which controls driving of the paper feed motor 22, a head driver 45 which controls driving of the printing head 60, a carriage motor driver 46 which controls driving of the carriage motor 32, and an interface 47 which connects each driver 43, 45, and 46 to the paper feed motor 22, printing head 60, and the carriage motor 32, respectively. The head driver 45 includes an oscillating circuit 48 which outputs a reference clock signal.

The control section 42 includes a CPU 51 which executes various arithmetic processes, a RAM 52 which temporarily stores and develops a program, or data, and a ROM 53 which stores a program or the like which is executed by the CPU 51. The various functions of the control section 42 can be executed when the CPU 51 is operated based on the program which is stored in the ROM 53. In addition, at least a part of the functions of the control section 42 may be executed when an electric circuit included in the control section 42 is operated based on a circuit configuration thereof.

When obtaining the printing data PD from the host computer 90 through the interface 41, the control section 42 executes a predetermined process with respect to the printing data PD, generates nozzle selection data (fire drive signal selection data) which defines from which nozzle of the printing head 60 the ink will be ejected, or how much ink will be ejected, and outputs a control signal to each driver 43, 45, and 46 based on the printing data PD, the fire drive signal selection data, or the like. Each driver 43, 45, and 46 outputs the fire drive signal which drives the paper feed motor 22, the printing head 60, and the carriage motor 32, respectively. For example, the head driver 45 supplies the reference clock signal SCK, a latch signal LAT, the driving signal selection signal SI & SP, a channel signal CH, and the fire drive signal COM to the printing head 60. When the paper feed motor 22, the printing head 60, the carriage motor 32 are operated according to the fire drive signal, the printing process to the sheet P is executed.

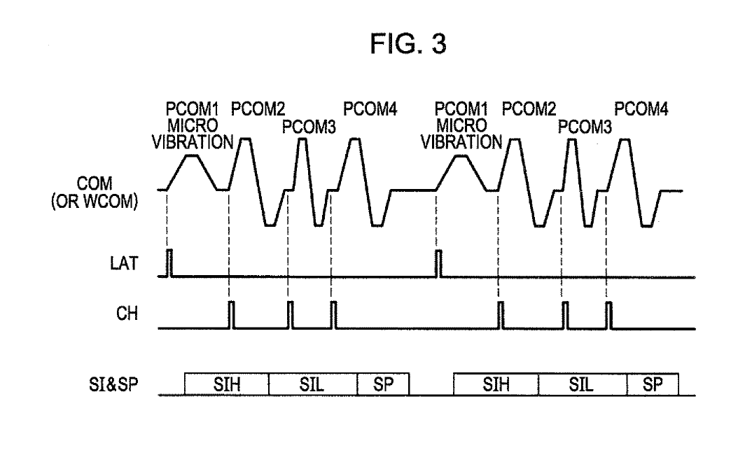

FIG. 3 is an explanatory diagram which illustrates an example of various signals which are supplied to the printing head 60. The fire drive signal COM is a signal which drives the nozzle actuator which is provided in the printing head 60. The fire drive signal COM is a signal in which driving pulses PCOM (driving pulses PCOM 1 to PCOM 4) as a minimum unit of the fire drive signal which drives the nozzle actuator is continuous in time sequence. A set of four driving pulses PCOM of driving pulses PCOM 1 to PCOM 4 corresponds to one pixel (printing pixel).

Each driving pulse PCOM is configured by a trapezoidal wave voltage. A rising portion of each driving pulse PCOM is a portion for drawing in ink (it can also be said as drawing meniscus in, when considering ejecting of ink) by enlarging a capacity of a cavity which communicates with a nozzle, and a rising portion of the driving pulse PCOM is a portion for pushing the ink out (it can also be said as pushing meniscus out, when considering ejecting of ink) by contracting the capacity of the cavity. For this reason, when the nozzle actuator is driven according to the driving pulse PCOM, ink is ejected from a nozzle.

In the fire drive signal COM, waveforms of the driving pulses PCOM 2 to PCOM 4 (inclination of increase or decrease in voltage, or peak wave) are different from each other. When the waveform of the driving pulse PCOM which is supplied to the nozzle actuator is different, an amount, or a speed of drawing ink in, and an amount, or a speed of pushing ink out become different, and due to this, an ejecting amount of ink becomes different (that is, size of ink dots). It is possible to form ink dots of many sizes by selecting one, or a plurality of driving pulses PCOM from among the driving pulses PCOM 2 to PCOM 4, and supplying the selected driving pulse PCOM to the nozzle actuator. In addition, according to the example, the driving pulse PCOM 1 which is referred to as micro vibration is included in the fire drive signal COM. The driving pulse PCOM 1 is used when ink is only drawn in, not being pushed out, for example, when suppressing thickening in the nozzle.

In this manner, the fire drive signal COM according to the example is a series of signals which are repeated in which a predetermined intermediate level is maintained for a certain period of time excluding a portion of the micro vibration driving pulse PCOM 1, and is gradually increased toward a predetermined high level from the intermediate level, the high level is maintained for a certain period of time, and is gradually reduced toward a predetermined low level from the high level, the low level is maintained for a certain period of time, and is gradually increased toward the intermediate level from the low level. In addition, in the present specification, when a signal maintains a certain level, it means that the signal is not practically (significantly) fluctuated from a certain level though minute fluctuation due to a noise, or an error is allowed. In addition, a level of the signal is a current value, or a voltage value.

The driving signal selection signal SI & SP is a signal which selects a nozzle which ejects ink based on the printing data PD, and determines a connection timing to the fire drive signal COM of the nozzle actuator. The latch signal LAT, and the channel signal CH are signals in which the fire drive signal COM and the nozzle actuator of the printing head 60 are caused to be connected to each other based on the driving signal selection signal SI & SP, after nozzle selection data of whole nozzle is input. As illustrated in FIG. 3, the latch signal LAT, and the channel signal CH are signals which are synchronized with the fire drive signal COM. That is, the latch signal LAT is a signal which becomes a high level corresponding to a start timing of the fire drive signal COM, and the channel signal CH is a signal which becomes a high level corresponding to a start timing of each driving pulse PCOM which configures the fire drive signal COM. Outputs of a series of fire drive signals (FDS) COM are started according to the latch signal LAT, and each driving pulse PCOM is output according to the channel signal CH. In addition, the reference clock signal SCK is a signal for transmitting the driving signal selection signal SI & SP to the printing head 60 as a serial signal. That is, the reference clock signal SCK is a signal which is used when determining a timing of ejecting ink from the nozzle of the printing head 60.

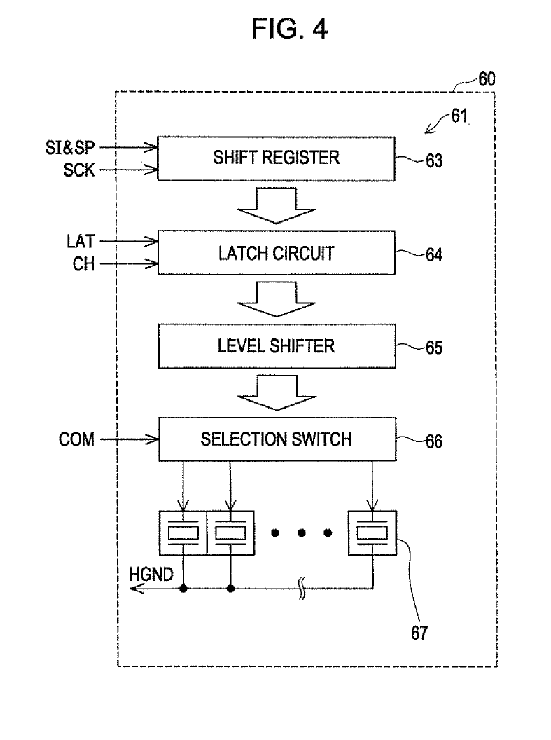

FIG. 4 is an explanatory diagram which illustrates a configuration of a switching controller 61 of the printing head 60. The switching controller 61 is built in the printing head 60 in order to supply the fire drive signal COM (driving pulse PCOM) to the nozzle actuator 67. The switching controller 61 includes a shift register 63 which stores the driving signal selection signal SI & SP, a latch circuit 64 which temporarily stores data of the shift register 63, a level shifter 65 which supplies an output of the latch circuit 64 to a selection switch 66 by performing a level conversion, and the selection switch 66 which connects the fire drive signal COM to the nozzle actuator 67.

The driving signal selection signal SI & SP is sequentially input to the shift register 63, and a region to be stored is sequentially shifted to a rear stage according to an input pulse of the reference clock signal SCK. In addition, the input of the driving signal selection signal SI & SP to the shift register 63 is executed according to the above described timing signal PTS. The latch circuit 64 latches each output signal of the shift register 63 according to the input latch signal LAT after the driving signal selection signals SI & SP by the number of nozzles are input to the shift register 63. The signal which is stored in the latch circuit 64 is converted to a voltage level in which the selection switch 66 can be switched (ON/OFF) in the next stage using the level shifter 65. The nozzle actuator 67 corresponding to the selection switch 66 which is closed due to an output signal of the level shifter 65 (becomes connected state) is connected to the fire drive signal COM (driving pulse PCOM) at a connection timing of the driving signal selection signal SI & SP. In addition, the next driving signal selection signal SI & SP is input to the shift register 63 after the driving signal selection signal SI & SP which is input to the shift register 63 is latched to the latch circuit 64, and stored data of the latch circuit 64 is sequentially updated according to an ink ejection timing. According to the selection switch 66, even after the nozzle actuator 67 is separated from the fire drive signal COM (driving pulse PCOM), an input voltage of the nozzle actuator 67 is maintained to a voltage which is immediately previous to the separation. In addition, the reference numeral HGND in FIG. 4 is a ground end of the nozzle actuator 67.

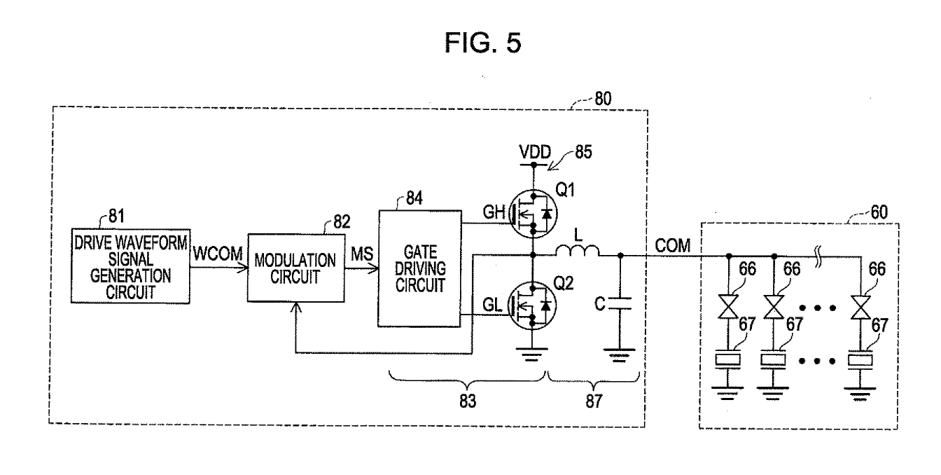

FIG. 5 is an explanatory diagram which illustrates a schematic configuration of a driving circuit 80 for driving the printing head 60. The driving circuit 80 is a circuit which generates the above described fire drive signal COM, and supplies the signal to the nozzle actuator 67 of the printing head 60, and is built in the control section 42 in the control unit 40, and in a head driver 45 (refer to FIG. 2). The driving circuit 80 includes a drive waveform signal generation circuit 81, a modulation circuit 82, a digital power amplification circuit (so-called class D amplifier) 83, and a smoothing filter 87.

The drive waveform signal generation circuit 81 generates a drive waveform signal WCOM as a reference of the fire drive signal COM which drives the nozzle actuator 67 based on drive waveform data DWCOM which is stored in advance. The drive waveform signal generation circuit 81 corresponds to an origin drive signal generation unit according to the embodiment of the present invention, and the drive waveform signal WCOM corresponds to the origin drive signal according to the embodiment of the present invention.

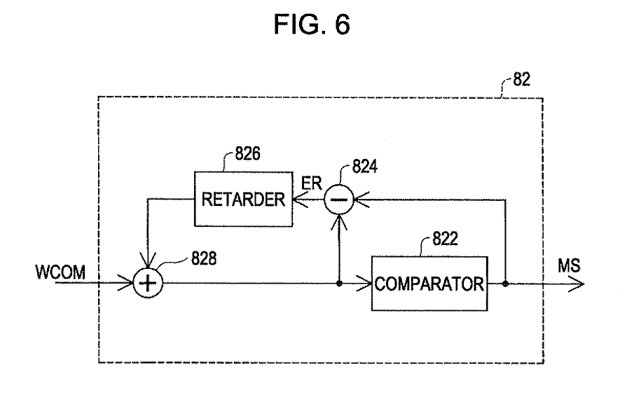

The modulation circuit 82 performs a pulse modulation with respect to the drive waveform signal WCOM which is generated in the drive waveform signal generation circuit 81, and outputs a modulation signal MS. The modulation circuit 82 corresponds to the signal modulation unit according to the embodiment of the present invention, and the modulation signal MS corresponds to the origin modulation signal according to the embodiment of the present invention. FIG. 6 is an explanatory diagram which illustrates a function block of the modulation circuit 82. The modulation circuit 82 is a so-called ΔΣ modulation circuit according to the example which performs a pulse modulation using a self oscillating-type pulse density modulation (PDM) method. The modulation circuit 82 includes a comparator 822 which outputs the modulation signal MS which becomes a high level when an input signal is a predetermined value or more when comparing the input signal to the predetermined value, a subtracter 824 which calculates an error ER between the input signal and an output signal of the comparator 822, a retarder 826 which retards the error ER, and an adder-subtracter 828 which adds or subtracts the retarded error ER to or from the drive waveform signal WCOM as the original signal. In addition, the modulation signal MS which is output from the modulation circuit 82 is a signal which denotes a waveform using a density of a pulse. In addition, it is also possible to omit the retarder 826 using an output of an external retarder, like a modulator in an example to be described later.

The digital power amplification circuit 83 (FIG. 5) amplifies power of the modulation signal MS which is output from the modulation circuit 82, and outputs a power amplification modulation signal. The digital power amplification circuit 83 corresponds to the signal amplification unit according to the embodiment of the present invention, and the power amplification modulation signal corresponds to the fire modulation signal according to the embodiment of the present invention.

The digital power amplification circuit 83 includes a half-bridge output stage 85 which is formed by two switching elements (switching element Q1 on high side, and switching element Q2 on low side) for substantially amplifying power, and a gate driving circuit 84 which adjusts signals between gate and source GH and GL of the switching elements Q1 and Q2 based on the modulation signal MS from the modulation circuit 82. In the digital power amplification circuit 83, when the modulation signal MS is a high level, the switching element Q1 on the high side becomes an ON state, since the signal between gate and source GH becomes a high level, and the switching element Q2 on the low side becomes an OFF state, since the signal between gate and source GL becomes a low level. As a result, an output of the half-bridge output stage 85 becomes a supply voltage VDD. On the other hand, when the modulation signal MS is a low level, the switching element Q1 on the high side becomes the OFF state, since the signal between gate and source GH becomes a low level, and the switching element Q2 on the low side becomes the ON state, since the signal between gate and source GL becomes a high level. As a result, an output of the half-bridge output stage 85 becomes zero. In this manner, the power amplification is performed in the digital power amplification circuit 83 by switching operation of the switching element Q1 on the high side, and the switching element Q2 on the low side based on the modulation signal MS.

The smoothing filter 87 smoothens a power amplification modulation signal which is output from the digital power amplification circuit 83, generates the fire drive signal COM (driving pulse PCOM), and supplies the fire drive signal COM to the nozzle actuator 67 through the selection switch 66 of the printing head 60 (refer to FIG. 4). The smoothing filter 87 corresponds to the signal modulation unit according to the embodiment of the present invention. In the example, a low pass filter in which a combination of a capacitor C and a coil L is used as the smoothing filter 87 is used. The smoothing filter 87 attenuates and removes a modulation frequency component which is generated in the modulation circuit 82, and outputs the fire drive signal COM (driving pulse PCOM) having a waveform property which is described above.

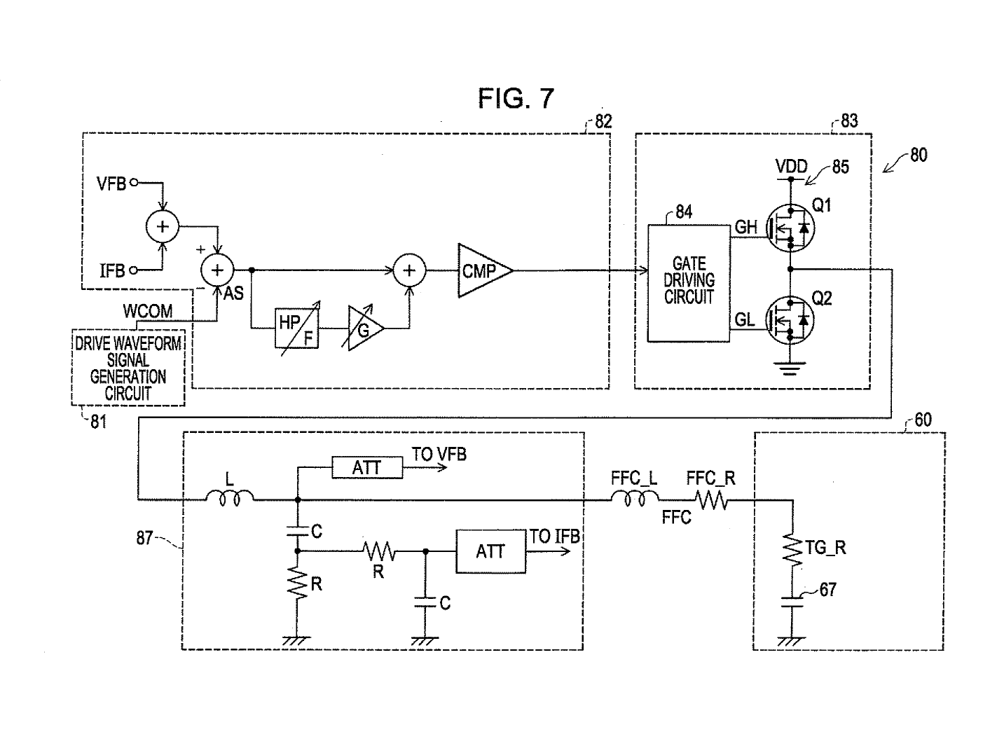

FIG. 7 is an explanatory diagram which illustrates an example of a specific functional configuration of the driving circuit 80. As described above, the modulation circuit 82 according to the example is a modulation circuit of the pulse density modulation method. In addition, the driving circuit 80 according to the example is different from the ΔΣ modulation circuit in FIG. 6, and use a modulator not having a retarder. Since the low pass filter is another expression of the retarder, an output of an LC low pass filter (COM) is used as a retarding signal instead of the retarder. In addition, according to the example, a circuit which emphasizes high frequency components (high pass filter (HP-F) and high frequency boost (G)), and a circuit which returns the high frequency components (denoted by “IFB”) are added thereto. That is, in the example, the modulation circuit 82 receives the modulation signal MS after being amplified by the digital power amplification circuit 83 as a returning signal, and corrects the generated modulation signal MS.

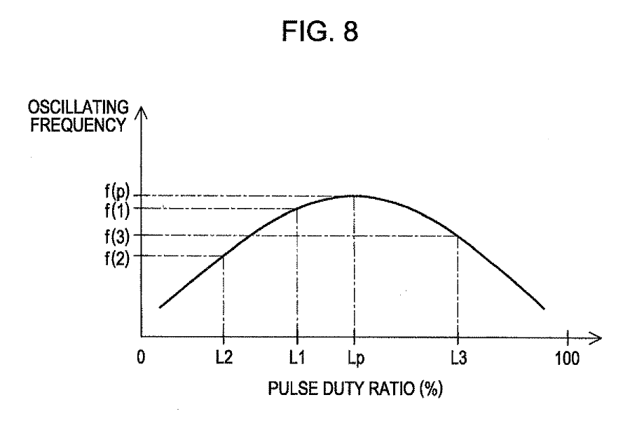

The modulation method in the modulation circuit 82 according to the example is the self oscillating-type pulse density modulation method, and the oscillating frequency fluctuates according to the signal level (pulse duty ratio) of the input drive waveform signal WCOM. FIG. 8 is an explanatory diagram which illustrates an oscillating frequency in the modulation circuit 82. As illustrated in FIG. 8, the oscillating frequency in the modulation circuit 82 becomes highest when the level of the input signal is an intermediate value, and becomes low when the level of the input signal becomes large, or smaller than the intermediate value.

That is, in the oscillating property in the modulation circuit 82, when a signal level of the drive waveform signal WCOM is in a range of a predetermined level Lp or less, the oscillating frequency is increased along with the increase in level of the drive waveform signal WCOM, and when the signal level of the drive waveform signal WCOM is in a range of the predetermined level Lp or more, the oscillating frequency is decreased along with the increase in level of the drive waveform signal WCOM. In addition, the oscillating property can also be expressed as a property in which the oscillating frequency at the time when the drive waveform signal WCOM is lower than the predetermined level Lp is lower than the oscillating frequency at the time when the drive waveform signal WCOM is the predetermined level Lp, and the oscillating frequency at the time when the drive waveform signal WCOM is higher than the predetermined level Lp is also lower than the oscillating frequency at the time when the drive waveform signal WCOM is the predetermined level Lp. Alternatively, the oscillating property can be expressed as a property in which the first level L1, the second level L2, and the third level L3 are present in which the oscillating frequency f(1) at the time when the drive waveform signal WCOM is the first level L1 is larger than both the oscillating frequency f(2) at the time when the drive waveform signal WCOM is the second level L2 which is smaller than the first level L1 and the oscillating frequency f(3) at the time when the drive waveform signal WCOM is the third level L3 which is larger than the first level L1.

Since the modulation circuit 82 according to the example has the above described oscillating property, above described below, it is possible to obtain a large variation width of the pulse duty ratio compared to the modulation circuit of the pulse width modulation method in which the modulation frequency is fixed, and to secure a wide output dynamic range.

That is, since the minimum positive pulse width and negative pulse width which can be treated in the modulation circuit are limited due to the circuit characteristics, a pulse signal which is less than that is lost on the way. For this reason, in the pulse width modulation method in which the frequency is fixed, only the pulse duty ratio variation width in a predetermined range (for example, 10% to 90%) can be secured. In contrast to this, since the oscillating frequency becomes low when the level of the input signal becomes large, or smaller than the intermediate value in the modulation circuit 82 of the self oscillating-type pulse density modulation method according to the example, it is possible to treat a signal of which the pulse duty ratio is larger, at a portion at which the level of the input signal is large, and to treat a signal of which the pulse duty ratio is smaller, at a portion at which the level of the input signal is extremely small, accordingly, the pulse duty ratio variation width in a wider range (for example, 5% to 95%) can be secured. Hereinafter, a specific example will be described. For example, if it is assumed that the minimum positive/negative pulse width which can be treated in the entire circuit is 25 ns, when the modulation frequency is 4 MHz which is fixed, only the pulse duty ratio variation width of 10% to 90% can be secured, since the pulse duty ratio variation width is determined using a ratio to the period. On the other hand, in the modulation circuit 82 of the self oscillating-type pulse density modulation method according to the example, the oscillating frequency is changed according to the level of the input signal, and for example, when the oscillating frequency is set to 2 MHz in both the low input signal level and high input signal level, it is possible to secure the pulse duty ratio variation width of 5% to 95%. In this manner, it is possible to secure a wide output dynamic range.

In addition, in the self oscillating-type pulse density modulation method according to the example, it is not necessary to provide an external circuit which generates a high frequency signal as in the non-self oscillating modulation type in which the frequency is fixed, it is advantageous in system configuration, for example, in which configuring the system in one chip is relatively easy.

In addition, since the signal level Lp of the drive waveform signal WCOM of the modulation circuit 82 in which the oscillating frequency becomes the maximum fluctuates according to the configuration of the modulation circuit 82, it is possible to set a desired value by adjusting the configuration of the modulation circuit 82. It is possible to set the signal level Lp to be 0.4 times or more and 0.6 times or less of the maximum level of the drive waveform signal WCOM, and more preferable to set to be 0.45 times or more and 0.55 times or less of the maximum level of the drive waveform signal WCOM.

As described above, in the printer 100 according to the example, in the oscillating property of the modulation circuit 82, the oscillating frequency at the time when the drive waveform signal WCOM is lower than the predetermined level Lp is lower than the oscillating frequency at the time when the drive waveform signal WCOM is the predetermined level Lp, and the oscillating frequency at the time when the drive waveform signal WCOM is higher than the predetermined level Lp is also lower than the oscillating frequency at the time when the drive waveform signal WCOM is the predetermined level Lp, accordingly, it is possible to secure the wide output dynamic range of the fire drive signal COM.

More specifically, in the oscillating frequency of the modulation circuit 82, the oscillating frequency is increased along with the increase in level of the drive waveform signal WCOM when the signal level of the drive waveform signal WCOM is in a range of the predetermined level Lp or less, and the oscillating frequency is decreased along with the increase in level of the drive waveform signal WCOM when the signal level of the drive waveform signal WCOM is in a range of the predetermined level Lp or more. For this reason, since the modulation circuit 82 is able to treat a signal of which the pulse duty ratio is larger at a portion at which the level of the drive waveform signal WCOM is extremely large, and to treat a signal of which the pulse duty ratio is smaller at a portion at which the level of the drive waveform signal WCOM is extremely small, it is possible to secure the pulse duty ratio variation width of a wider range. For this reason, it is possible to secure the wider output dynamic range of the fire drive signal COM.

### B. Modification Example

In addition, the invention is not limited to the above described examples, or embodiments, and can be executed in various modes without departing from the scope of the invention. For example, it is possible to perform the following modifications.

### B1. Modification Example 1

The configuration of the printer 100 according to the example is only an example, and can be variously modified. For example, in the example, the piezoelectric element is used as the nozzle actuator 67, however, another nozzle actuator may be used.

In addition, in the above described example, the printer 100 performs the printing process by receiving printing data from the host computer 90, however, instead of this, for example, the printer 100 may perform the printing processing by generating printing data PD based on image data which is obtained from a memory card, image data which is obtained from a digital camera through a predetermined interface, image data which is obtained by a scanner, or the like.

In addition, in the above described example, the printer 100 is a printer which performs printing while repeating an operation of reciprocating the printing head 60 (main scanning) with respect to a continuous sheet P which is located in a printing region in the predetermined direction (main scanning direction), and an operation which transports the sheet P in the transport direction which intersects the main scanning direction (sub-scanning direction), however, the present invention can also be applied to a so-called impact printer which performs printing on a cut sheet, or a so-called line printer which performs printing while transporting a sheet in a direction intersecting the sheet width direction under the nozzle columns which are arranged in line across the sheet width direction at the base of the printing head.

In addition, the present invention can also be applied to apparatuses other than the ink jet printer, if it is an apparatus which ejects liquid (including a fluidal body such as a liquid body in which particles of functional material are dispersed, gel, or the like). As such a liquid ejecting apparatus, there are, for example, a textile printing device which prints patterns on cloth, a device which ejects a liquid body including an electrode material which is used when manufacturing a liquid crystal display, an Electro Luminescence (EL) display, a plane emission display, a color filter, or the like, a color material, or the like, in a form of a dispersion, or a dissolution, an image recording apparatus which ejects a biological organic substance which is used when manufacturing a biochip, an apparatus which ejects liquid as a sample which is used as precision pipette, an apparatus which ejects a lubricant to a precision machine such as a clock, a camera, or the like, using a pin point, an apparatus which ejects transparent resin liquid such as UV curable resin for forming a micro bulls-eye lens (optical lens) which is used in an optical communication element, or the like, onto a substrate, and an apparatus which ejects etching liquid such as acid or alkali for etching a substrate or the like.

In addition, in the above described example, a part of the configuration which is executed using hardware may be substituted by software. On the contrary, a part of the configuration which is executed using software may be substituted by hardware.

In addition, when a part, or all of functions of the present invention are executed using the software, the software (computer program) can be provided in a form of being stored in a computer readable recording medium. In the invention, the “computer readable recording medium” is not limited to a portable recording medium such as a flexible disk, or a CD-ROM, and also includes an internal storage unit in a computer such as various RAMs, ROMs, or the like, or an external storage unit which is fixed to a computer such as a hard disk.

### B2. Modification Example 2

The oscillating property of the modulation circuit 82 according to the example is only an example, and it is possible to perform various modifications as long as having properties (oscillating frequency at the time when the drive waveform signal WCOM is lower than the predetermined level Lp is lower than the oscillating frequency at the time when the drive waveform signal WCOM is the predetermined level Lp, and the oscillating frequency at the time when the drive waveform signal WCOM is higher than the predetermined level Lp is also lower than the oscillating frequency at the time when the drive waveform signal WCOM is the predetermined level Lp, or the oscillating property can be expressed as a property in which the first level L1, the second level L2, and the third level L3 are present in which the oscillating frequency f(1) at the time when the drive waveform signal WCOM is the first level L1 is larger than both the oscillating frequency f(2) at the time when the drive waveform signal WCOM is the second level L2 which is smaller than the first level L1 and the oscillating frequency f(3) at the time when the drive waveform signal WCOM is the third level L3 which is larger than the first level L1) which are described in the above described example. For example, a line in FIG. 8 denoting the oscillating frequency of the modulation circuit 82 forms a convexly curved line when the point of the signal level Lp forms the apex, however, the line denoting the oscillating property may include a linear portion, or a convexly curved portion downwardly.

### B3. Modification Example 3

The elements other than elements which are described in the aspect among constituent elements in the above described embodiments, examples and modification examples are additional elements, and can be suitably omitted, or combined.

The entire disclosure of Japanese Patent Application No. 2012-010660, filed Jan. 23, 2012 is expressly incorporated by reference herein.

What is claimed is:

1. A liquid ejecting apparatus comprising:
an origin drive signal generation unit which generates an origin drive signal;
a signal modulation unit which generates an origin modulation signal by modulating the origin drive signal using a self oscillating-type pulse density modulation method;
a signal amplification unit which generates a fire modulation signal by amplifying the origin modulation signal;
a signal conversion unit which converts the fire modulation signal to a fire drive signal; and
a liquid ejection unit which ejects liquid according to a fire drive signal,
wherein, a frequency of the origin modulation signal, or the fire modulation signal is lower than the frequency when the origin drive signal is a predetermined value, if the origin drive signal is lower than the predetermined value, and is also lower than the oscillating frequency when the origin drive signal is the predetermined value, even if the origin drive signal is higher than the predetermined value.

2. The liquid ejecting apparatus according to claim 1,
wherein the oscillating property of the signal modulation unit is that the frequency is increased along with an increase in a current value, or a voltage value of the origin drive signal when the origin drive signal is in a range of the predetermined value or less, and is decreased along with the increase in the current value, or the voltage value of the origin drive signal when the origin drive signal is in a range of the predetermined value or more.

3. The liquid ejecting apparatus according to claim 1,
wherein the signal modulation unit receives the fire modulation signal as a feedback signal, and corrects the generated origin modulation signal.

4. A liquid ejecting method comprising:
generating an origin drive signal;
generating an origin modulation signal by modulating the origin drive signal using a self oscillating-type pulse density modulation method;
generating a fire modulation signal by amplifying the origin modulation signal;
converting the fire modulation signal to a fire drive signal; and
ejecting liquid according to the fire drive signal,
wherein a frequency of the origin modulation signal, or the fire modulation signal is lower than the frequency when the origin drive signal is the predetermined value if the origin drive signal is lower than a predetermined value, and is also lower than the frequency when the origin drive signal is the predetermined value, even if the origin drive signal is higher than the predetermined value.
